(19) United States
(12) Patent Application Publication
(10) Pub. No.: US 2016/0257349 A1
(43) Pub. Date: Sep. 8, 2016

(54) SERVICE PANEL FOR A MOTOR VEHICLE, WATER TANK FOR A MOTOR VEHICLE AND MOTOR VEHICLE

(71) Applicant: GM GLOBAL TECHNOLOGY OPERATIONS LLC, Detroit, MI (US)

(72) Inventors: Fabian KEMPFER, Ruesselsheim (DE); Younes CHLYEH, Ruesselsheim (DE); Peter ZIPP, Ruesselsheim (DE)

(73) Assignee: GM GLOBAL TECHNOLOGY OPERATIONS LLC, Detroit, MI (US)

(21) Appl. No.: 15/059,661

(22) Filed: Mar. 3, 2016

(30) Foreign Application Priority Data
Mar. 4, 2015 (DE) 102015002701.8

(51) Int. Cl. B62D 25/08; B62D 25/12; B60R 16/08; B62D 29/04

(52) U.S. Cl. CPC B62D 25/081; B62D 29/043; B62D 25/12; B60R 16/08

(57) ABSTRACT

A service panel for a motor vehicle is disposed between a bulkhead that separates an engine compartment and a passenger cabin from one another and a vehicle bonnet of the motor vehicle to bridge an intermediate space between the bulkhead and the vehicle bonnet. The service panel has a first end having the form of a bulkhead connecting zone and a second end, opposite the first end, having the form of a bonnet connecting zone. The second end is designed as a bonnet seal for sealing the service panel off from vehicle bonnet.

### CROSS-REFERENCE TO RELATED APPLICATION

This application claims priority to German Patent Application No. 102015002701.8, filed Mar. 4, 2015, which is incorporated herein by reference in its entirety.

### TECHNICAL FIELD

The present disclosure pertains to a service panel for a motor vehicle, a water tank for a motor vehicle which has such a service panel, and a motor vehicle having such a water tank.

### BACKGROUND

In standard motor vehicles, a front space, particularly an engine compartment, is separated from a passenger cabin by a bulkhead, which stiffens the chassis of the motor vehicle transversely with respect to the longitudinal direction of the vehicle. To ensure that the chassis is able to yield over its entire area, particularly if an object strikes the vehicle bonnet, the bulkhead does not extend fully as far as the outer skin of the chassis. instead, a relatively easily deformable panel element, also referred to as a service panel, is attached to an upper edge area of the bulkhead to bridge an intermediate space between the bulkhead and the bonnet.

Document DE 20 2013 004 205 U1 discloses an assembly for a motor vehicle including a service panel for bridging an intermediate space between a bulkhead in the motor vehicle that separates an engine compartment from a passenger cabin and a vehicle bonnet. The assembly includes a strut that is secured to the service panel to connect it with the front windscreen cross member. The strut is divided by a hinge into a section that is attached fixedly to the service panel and a section that is pivotable relative to the service panel, and has a fastener for securing it to the front windscreen cross member. The service panel may be furnished with an elastic bonnet seal which is in sealing contact with a rear part of the vehicle bonnet when fitted.

### SUMMARY

The present disclosure provides a service panel for a motor vehicle and a water tank for a motor vehicle including a service panel of such kind, which are of simple design and can he installed in the motor vehicle inexpensively and without excessive labor.

According to one embodiment of the present disclosure a service panel for a motor vehicle is disposed between a bulkhead of a motor vehicle that separates an engine compartment and a passenger cabin from one another and a bonnet of the motor vehicle to bridge an intermediate space between the bulkhead and the bonnet, and which has a first end having the form of a bulkhead connecting zone and a second end, opposite the first end, having the form of a bonnet connecting zone. The second end is designed as a bonnet seal, for the purpose of sealing the service panel with respect to the bonnet.

Thus, the bonnet seal is formed, not as a separate component, but integrated in the service panel. That is to say the bonnet seal conforms to the service panel, by molding, for example. In this context, a service panel is understood to he cover for an opening in a bulkhead that separates an engine compartment and a passenger cabin, allowing access to the engine compartment. The service panel may be fastened to the bulkhead either detachably or non-detachably, or at least not detachably without destroying the assembly, particularly by positive, frictional or material joining means, for instance by interlocking, screwing, adhesive bonding or the like.

A service panel of such kind has the advantage that it is of simple design and can be fitted in the vehicle inexpensively and without great effort. In particular, the service panel with integrated bonnet seal can be installed in the vehicle more easily and less expensively than the conventional assemblies for motor vehicles, which have a separate bonnet seal as well as a service panel. For example, since the bonnet seal is already an integral pail of the service panel, it does not need to he installed or attached further, and the work steps and fastening means therefor, such as screws, expansion clips or pressure pins may be dispensed with, which results in reduced assembly costs. Since the bonnet seal is integrated in the service panel, it also has an improved sealing effect compared with the usual assemblies for motor vehicles, which have a separate bonnet seal as well as a service panel.

In this context, the bonnet seal may be a sealing lip, particularly a cast-on sealing lip, which is positioned flush with the bonnet to form a liquid-impermeable seal when the service panel is installed, thus reliably sealing a contact point with the vehicle bonnet and so guaranteeing an optimum seal of the bonnet.

The bonnet seal may also be a concave sealing element, for example a pear-shaped sealing element. In this context, a pear-shaped sealing element is understood to mean that the bonnet seal has a concave or mushroom-shaped profile. Such a concave, e.g., pear-shaped sealing element then in turn provides a contact area with the vehicle bonnet large enough to ensure a reliable, liquid-impermeable seal.

Moreover, the service panel may be made from a first plastic material with a first degree of hardness, the bonnet seal may be made from a second plastic material with a second degree of hardness, wherein the second degree of hardness has a lower value than the first degree of hardness. In particular, the service panel may thus be constructed from a hard plastic material and the bonnet seal from a soft plastic material, The elastic properties of the soft plastic thus make it possible to guarantee an optimum sealing effect. Seals made from soft plastic can also be conformed on standard service panels, that is to say integrated therein, particularly by molding, easily and without great expense. Such soft plastic materials, particularly those with a polyurethane or silicone base, are known. However, the bonnet seal may also be produced by rubber coating, vulcanization or similar, and the service panel may be manufactured using a plastic material foam.

In a further embodiment of the present disclosure, a water tank for a motor vehicle is also described, having a service panel as described in the preceding text and a water tank cover engaged in interlocking manner with the service panel. Such a water tank has the advantage that it is of simple design and can be installed in the motor vehicle inexpensively and without great effort. In particular, the water tank can be installed in the vehicle more easily and less expensively than the conventional assemblies or water tanks for motor vehicles, which have a separate bonnet seal as well as a service panel. For example, since the bonnet seal is already an integral part of the service panel, it does not need to be installed or attached further, and the work steps and fastening means therefor, such as screws, expansion clips or pressure pins may be dispensed with, which results in reduced assembly costs. Since the bonnet seal is integrated in the service panel, it also has an improved sealing effect compared with the usual assemblies or water tanks for motor vehicles, which have a separate bonnet seal as well as a service panel.

Moreover, the service panel and the water tank cover may be supplied and installed in the vehicle as a prefabricated assembly instead of being assembled at the same time as they are being installed in the vehicle. In such circumstances, the fact that the service panel and the water tank cover are in or can be placed in interlocking engagement has the further advantage that no additional fastening means such as screws, expansion clips or pressure pins are needed to join the service panel to the water tank cover, and also no additional sealing elements to seal this joint, to prevent water ingress, for example, and the work steps associated therewith may also be dispensed with, so that the necessary installation costs may be lowered further. Thus in all, overall convenience of maintaining both the water tank assembly as a unit and the individual components thereof may also be improved significantly.

In this context, the water tank cover may have a first end in the form of a front windscreen connecting, zone and a second end located opposite the first end in the form of a service panel connecting zone, and the service panel may have a retaining element, in which the second end of the water tank cover is inserted. The second end of the water tank cover may be fixed and thus held firmly in place in the retaining element by adhesive bonding, warm caulking or by an interlocking mechanism, for example, without the need for additional connecting elements in order to bond the service panel to the water tank cover or additional sealing elements to seal this joint.

in a further embodiment of the present disclosure, a motor vehicle that is equipped with a water tank according to the preceding text is also described. Such a motor vehicle has the advantage that it has a water tank that has a service panel, a bonnet seal integrated in the service panel, and a water tank cover, the water tank is of simple design and can be installed in the motor vehicle inexpensively and without great effort. In particular, the components—that is to say the service panel with integrated bonnet seal—can be installed in the vehicle more easily and less expensively than the conventional assemblies or water tanks for motor vehicles, which have a separate bonnet seal as well as a service panel. For example, since the bonnet seal is already an integral part of the service panel, it does not need to be installed or attached further, and the work steps and fastening means therefor, such as screws, expansion clips or pressure pins may be dispensed with, which results in reduced assembly costs. Since the bonnet seal is integrated in the service panel, it also has an improved sealing effect compared with the usual assemblies or water tanks for motor vehicles, which have a separate bonnet seal as well as a service panel. Moreover, the service panel and the water tank cover may be supplied and installed in the vehicle as a prefabricated water tank assembly instead of being assembled at the same time as they are being installed in the vehicle. In such circumstances, the fact that the service panel and the water tank cover are in or can be placed in interlocking engagement has the further advantage that no additional fastening means such as screws, expansion clips or pressure pins are needed to join the service panel to the water tank cover, and no additional sealing elements to seal this joint, to prevent water ingress, for example, and the work steps associated therewith may also be dispensed with, so that the necessary installation costs may be lowered further. Thus in all, overall convenience of maintaining both the water tank assembly as a unit and the individual components thereof and consequently. of the motor vehicle as a whole may be improved significantly.

In summary, it should be noted that the present disclosure provides a service panel for a motor vehicle and a water tank for a motor vehicle, which water tank includes such a service panel, both of which are of simple design and can be installed in the motor vehicle simply and without great effort.

Thus, since the bonnet seal is not constructed as a separate component, but instead is integrated in the service panel, which means that the bonnet seal is conformed on the service panel, molded for example, joining means required for fitting the bonnet seal, such as screws, expansion clips or pressure pins as well as the work steps associated therewith may be dispensed with, and consequently the necessary installation costs can be reduced.

Since the service panel and the water tank cover may also be brought into interlocking engagement, additional joining means such as screws for connecting the service panel to the water tank cover, and sealing elements to seal said joint, are also not needed, and this in turn eliminates the work steps that would otherwise be necessitated therefor, so that the necessary fitting costs may be further reduced.

Overall, this makes it possible to significantly improve the convenience of maintaining the water tank assembly consisting of a service panel, bonnet seal and water tank cover and of the individual components thereof.

### BRIEF DESCRIPTION OF THE DRAWINGS

The present disclosure will hereinafter be described in conjunction with the following drawing figures, wherein like numerals denote like elements.

FIG. 1 is a schematic view of a water tank for a motor vehicle according to a first embodiment of the present disclosure;

FIG. 2 is a schematic view of a water tank for a motor vehicle according to a second embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

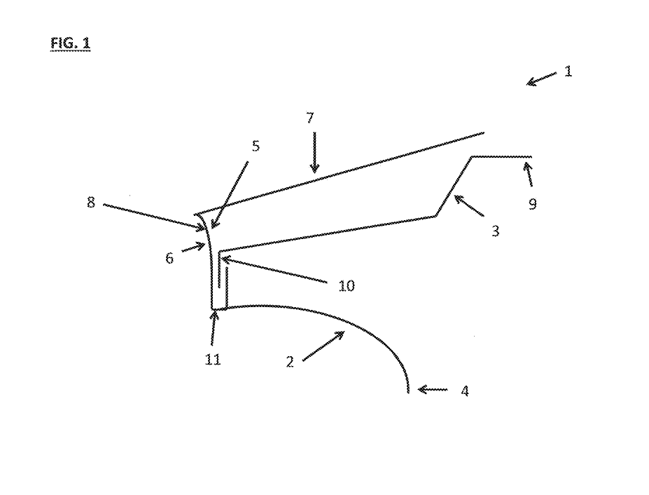

FIG. 1 shows a schematic view of a water tank 1 for a motor vehicle according to a second embodiment of the present disclosure. As is shown in FIG. 1, water tank 1 includes a service panel 2 and a water tank cover 3, Service panel 2 is understood to be cover for an opening in a bulkhead that separates an engine compartment and a passenger cabin, allowing access to the engine compartment.

Service panel 2 may be fastened to the bulkhead either detachably or non-detachably, or at least not detachably without destroying the assembly, particularly by positive, frictional and/or material joining means, for instance by interlocking, screwing, adhesive bonding or the like. Service panel 2 may be produced as a single part by injection molding.

In addition, a water tank on a motor vehicle is typically located on a bottom edge of the front windscreen thereof, or of a similar window support, and serves to accommodate various components such as windscreen wiper motors and linkages, for example. in this context, water tank cover 3 is provided in order to prevent water and dirt running down the windscreen from getting into the water tank.

As may be seen, service panel 2 has a first end 4 having the form of a bulkhead connecting zone and a second end 5, opposite the first end and having the form of a bonnet connecting zone. As is shown in FIG. 1, second end 5 of service panel 2 is designed as a bonnet seal 6, which is in sealing contact with a rear part of a bonnet 7 of the motor vehicle when fitted.

With regard to such water tanks for motor vehicles, the service panel, the water tank cover and bonnet seal are typically designed as separate components, which must each be attached to each other, by means of screws or expansion clips, for example. However, this makes the water tank less convenient to maintain and entails significant labor and corresponding assembly costs.

According to the embodiment of FIG. 1, bonnet seal 6 is now integrated in service panel 2, that is to say it is conformed on said service panel 2, by molding, for example, in such manner that when service panel 2 is installed in the motor vehicle, the second end 6 of service panel 2 is facing in the direction of vehicle bonnet 7 and functions as a bonnet seal 6 which insulates service panel 2 from vehicle bonnet 7, Since bonnet seal 6 is already integrated in service panel 2, an extra step of fitting said seal 6 is not required, so the necessary work steps and connecting means, such as screws, expansion clips or pressure pins may be dispensed with. Since bonnet seal 6 is integrated in service panel 2, the seal 6 also has a better sealing effect than motor vehicle water tanks, since the latter typically have a separate bonnet seal as well as a service panel.

According to the embodiment of FIG. 1, bonnet seal 6 is constructed as a sealing lip 8. This sealing lip 8 is positioned flush with the bonnet to form a liquid-impermeable seal when service panel 2 is installed, thus reliably sealing a contact point with vehicle bonnet 7 and so guaranteeing an optimum seal of the vehicle bonnet 7.

Also according to the embodiment of FIG. 1, service panel 2 is made from a first plastic material with a first degree of hardness, and bonnet seal 6 is made from a second plastic material with a second degree of hardness, wherein the second degree of hardness has a lower value than the first degree of hardness. Bonnet seal 6 may thus be made from a soft plastic material. However, the bonnet seal may also be produced by rubber coating, vulcanization or similar.

As is further shown in FIG. 1, service panel 2 and water tank cover 3 are in interlocking engagement. Since service panel 2 and water tank cover 3 are or may be brought into interlocking engagement, it is also possible to eliminate additional joining means, such as screws, expansion clips or pressure pins for joining the service panel to the water tank cover as well as additional sealing elements to seal said joint, for preventing the ingress of water, for example, and the associated work steps may also be dispensed with, so that installation costs can be further reduced.

In the context, water tank cover 3 has a first end 9 in the form of a front windscreen connecting zone and a second end 10 in the form of a service panel. Service panel 2 further has a retaining element 11, in which the second end 10 of water tank cover 3 is inserted. The second end 10 of water tank cover 3 may be fixed and thus held firmly in place in retaining element 11 by adhesive bonding, warm caulking or by an interlocking mechanism, for example.

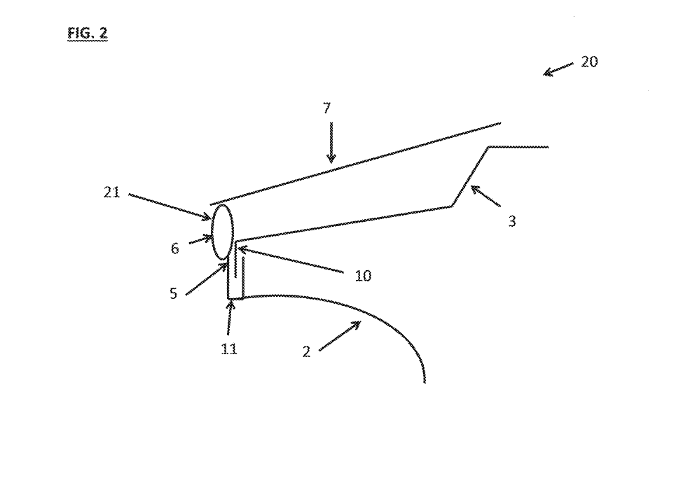

FIG. 2 is a schematic view of a water tank 20 for a motor vehicle according to a second embodiment of the present disclosure. Components and parts having the same function or design as in FIG. 1 are also designated with the same reference sign and are not described again.

According to the embodiment of FIG. 2, bonnet seal 6 is concave, in particular pear-shaped, that is to say bonnet seal 6 is a concave, pear-shaped sealing element 21. The term pear-shaped sealing element 21 is understood in this case to mean that bonnet seal 6 has a pear-shaped or mushroom-shaped profile. Such a concave, pear-shaped sealing element provides a contact area with the vehicle bonnet 7 large enough to ensure a reliable, liquid-impermeable seal.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-7. (canceled)

8. A service panel for a motor vehicle configured to be disposed between a bulkhead that separates an engine compartment and a passenger cabin from one another and a vehicle bonnet of the motor vehicle to bridge an intermediate space between the bulkhead and the vehicle bonnet, wherein the service panel comprises a first end having the form of a bulkhead connecting zone and a second end opposite the first end having the form of a bonnet connecting zone, wherein the second end includes a bonnet seal for sealing the service panel off from vehicle bonnet.

9. The service panel according to claim 8, wherein the bonnet seal comprises a sealing lip.

10. The service panel according to claim 8, wherein the bonnet seal comprises a concave sealing element.

11. The service panel according to claim 8, wherein the service panel comprises a first plastic material having a first degree of hardness, and the bonnet seal comprises a second plastic material having a second degree of hardness, wherein the second degree of hardness has a lower value than the first degree of hardness.

12. A water tank for a motor vehicle, comprising a service panel according to claim 8 and a water tank cover in interlocking engagement with the service panel.

13. The water tank according to claim 12, wherein the water tank cover has a first end in the form of a front windscreen connection zone and a second end, opposite the first end, in the form of a service panel connection zone, wherein the service panel comprise a retaining element in which the second end of the water tank cover is inserted.

14. The motor vehicle having a water tank according to claim 12.
